(19) United States
(12) Patent Application Publication
(10) Pub. No.: US 2011/0117359 A1
(43) Pub. Date: May 19, 2011

(54) COATING COMPOSITION, COATED ARTICLE, AND RELATED METHODS

(76) Inventors: Juan M. de Santos Avila, Temple City, CA (US); Ali R. Mehrabi, Glendale, CA (US); Ming Shi, Arcadia, CA (US)

(21) Appl. No.: 12/619,652

(22) Filed: Nov. 16, 2009

(51) Int. Cl. B32B 5/16; C08K 7/00

(52) U.S. Cl. 428/325; 428/323; 428/327; 428/329; 428/328; 428/330; 523/205; 523/209

(57) ABSTRACT

A coating composition, method of making the coating composition, a printable media including the coating composition is described. The coating composition includes a solid material including particles and a binder material. The solid material particles have an estimated concavity value greater than approximately 0.1.

### BACKGROUND

There are various types of printable media on the market for printing applications, such as paper, topcoated paper, and artificial paper. Some printable media works well with only an ink jet printer or a laser printer, but not both. In addition, some printable media cannot be written upon with writing instruments, such as pencils, pens, markers, or highlighters.

In one particular application, the printable media can be used as a name badge. Most printable media used as name badges are either paper-based printable media or polyvinyl chloride (PVC)-based printable media. Because paper-based name badges are not as flexible as most of the fabrics they are attached to, the badges tend to fall off even though pressure sensitive adhesives with high adhesion are used. High-adhesion pressure sensitive adhesives can also damage certain fabrics when an adhered name badge is removed. On the other hand, PVC-based name badges are flexible; however, there is increasing awareness of the environmental and health effects of PVC products in recent years. Currently, there is a movement to reduce or eliminate PVC-based products.

Therefore, there is a need for flexible printable and writable products. Furthermore, there is a need for non-PVC-based flexible name badges that are printable and writable.

### SUMMARY

The current invention seeks to address the problems mentioned above. In particular, a topcoat suitable for use with both flexible and stiff substrates is described.

In an embodiment of the invention, a coating composition includes a solid material and a binder material. The solid material includes particles that have an estimated concavity. The solid material and the binder material are in a water-based suspension. The estimated concavity of the solid material particles is greater than approximately 0.1.

In another embodiment of the invention, a method for manufacturing a coating composition includes the steps of providing solid material, providing a suspended binder material, dispersing the solid material to make a slurry, and dispersing the suspended binder into the slurry. The solid material includes particles having an estimated concavity and the estimated concavity is greater than approximately 0.1.

In yet another embodiment of the invention, a printable media includes a substrate having a surface and a topcoat layer on the substrate surface. The topcoat layer includes a solid material and the solid material has particles having an estimated concavity. The topcoat also includes a binder. The estimated concavity of the solid material particles is greater than approximately 0.1.

Other features of the invention should become apparent to those skilled in the art from the following description of the preferred embodiments taken in conjunction with the accompanying drawings, which illustrate, by way of example, the principles of the invention, the invention not being limited to any particular preferred embodiment(s) disclosed.

### BRIEF DESCRIPTION OF THE DRAWINGS

FIG. 1 is a sectional illustration of one embodiment of an article according to the present invention;

FIG. 2 is a sectional illustration of one embodiment of an article according to the present invention;

FIG. 3 is a sectional illustration of one embodiment of an article according to the present invention;

FIG. 4 is a sectional illustration of one embodiment of an article according to the present invention;

FIG. 5 is an illustration of a solid particle;

FIGS. 6a to 6d is an illustration of the drying process of the coating according to the present invention;

FIG. 7 is an illustration of a solid particle.

FIG. 8 is a flow chart illustrates a manufacturing process for making one embodiment of the coating composition according to the present invention;

FIG. 9 is a top view of a label sheet according to the present invention;

FIG. 10 is a top view of a name badge according to the present invention;

FIG. 11 is a sectional illustration of one embodiment of an article according to the present invention; and

FIG. 12 is a top view of a business card sheet;

Unless otherwise indicated, the illustrations in the above figures are not necessarily drawn to scale.

### DETAILED DISCUSSION OF THE INVENTION

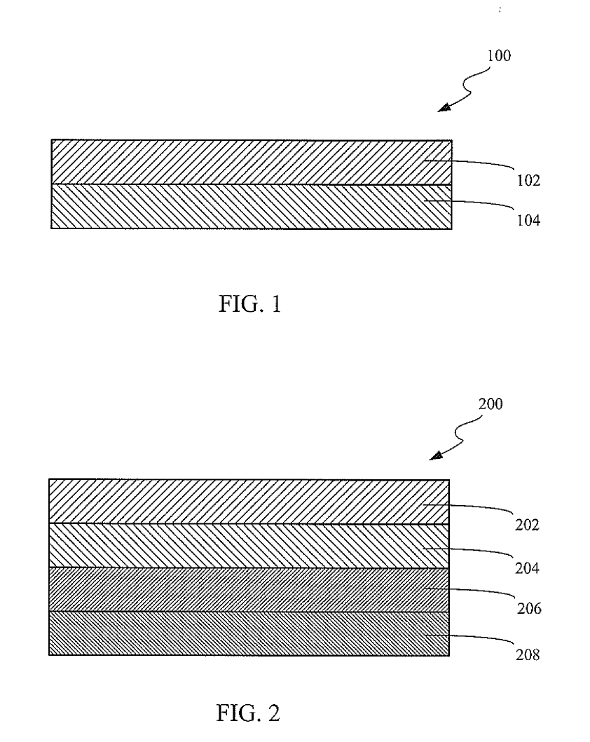

The present invention concerns a coating composition, a coated article, and related methods. FIG. 1 shows a coated article embodiment of the invention. The coated article 100 includes a topcoat layer 102 and a substrate layer 104. The topcoat layer will be described in greater detail below. Choice of the substrate layer depends on specific requirements in the final product. Suitable substrates can include, for example, paper, cardboard, corrugated board, polymeric films, including extruded and cast polymeric films, metallic films, foils, and laminates of any of these materials. Polymeric films include, for example, polycarbonate, polyolefin, such as polypropylene, polyethylene, and their copolymers, ethylene vinyl acetate and its copolymers, ethylene vinyl alcohol (EVOH), polyurethane, polyamides, polyesters, such as polyethylene terephthalate (PET), polysiloxane, silicone, elastomers such as styrene-butadiene rubber, ethylene propylene rubber, polyacrylic rubber, and biodegradable polymer films, such as polylactic acid.

The method of applying the coating composition to the substrate can be any of those known to one skilled in the art. Coating methods include, for example, die coating, slot die coating, curtain coating, wire coating, roll coating, rod coating, gravure coating, extrusion and printing. The method of choice will depend on the coating properties of the coating itself, and on properties of the desired substrate. In general, any method of applying the coating is suitable.

FIG. 2 shows another coated article embodiment of the invention. The coated article 200 includes a topcoat layer 202, a substrate layer 204, an adhesive layer 206, and a release liner 208. The topcoat layer is applied to one side of the substrate and an adhesive is applied to the other. A release liner can serve to protect the adhesive layer before use. An example of this embodiment is a pressure-sensitive label sheet.

Adhesives useful in the embodiment of FIG. 2 include, for example, pressure sensitive adhesives, such as removable adhesives, ultraremovable adhesives, permanent adhesives, and water resistant adhesives. Pressure sensitive adhesives include, for example, rubber-based, acrylic-based, and silicone-based pressure sensitive adhesives. Other useful adhesives include, for example, light-activatable adhesives, temperature activatable adhesives, and water activatable adhesives, gum-based adhesives and thermoplastic adhesives. Any adhesives known to one skilled in the art and suitable for the final application can be used.

Adhesives are generally coated as a contiguous layer, although the layer of adhesive can also be pattern-coated. European Patent No. 1282472 B1 to Avery Dennison Corporation and U.S. Pat. No. 4,889,234 to Sorensen, et al., disclose pattern-coating technology and are incorporated by reference herein in their entireties.

Similarly, any release liner suitable for the chosen adhesive can be used. For pressure sensitive adhesives, release liners can paper or film, for example. Materials suitable for release liners include, for example, silicone-based and fluorine-based materials, or any other material that has the desired releasing properties, for example, waxes and carbamates.

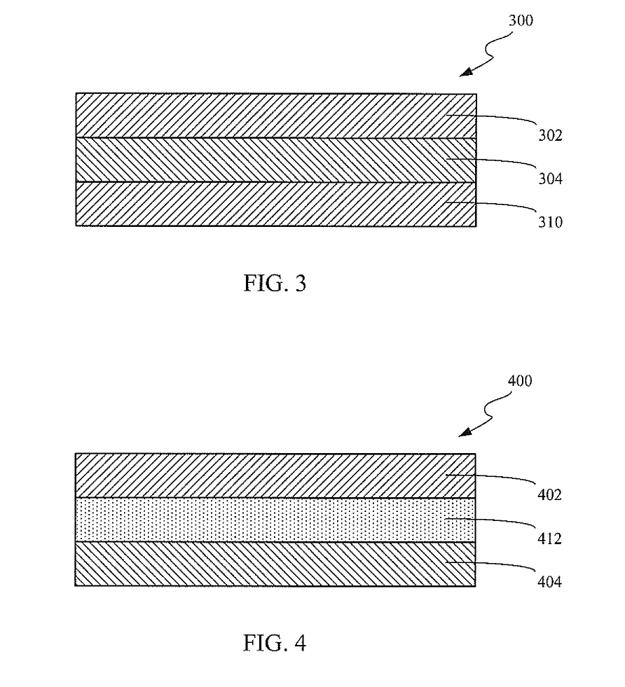

FIG. 3 shows yet another coated article embodiment of the invention. The coated article 300 includes a substrate layer 304 with a first topcoat layer 302 on one side and a second topcoat layer 310 on another side

FIG. 4 shows another coated article embodiment of the invention. The coated article 400 includes a topcoat layer 402, a primer layer 412, and a substrate layer 404. Primer layers increase adhesion of the topcoat layer to the substrate. Any primer known to those skilled in the art is suitable. Examples of primers include, for example, polyvinyl alcohols, polyvinyl acetates, acrylic copolymers, polyolefins, and polyvinyl butryals.

We will now turn our attention to the topcoat. The topcoat is coated from a suspension that includes solid particles (referred to as solid or filler) and a binder polymer (referred to as binder) particles. Both the solid particles and the binder polymer particles can be characterized as having a mean particle size. In some embodiments, the mean particle size of the solid particles is equal to or larger than one third that of the binder polymer particles. In other embodiments, the mean particle size of the solid particles is equal to or larger than that of the binder polymer particles.

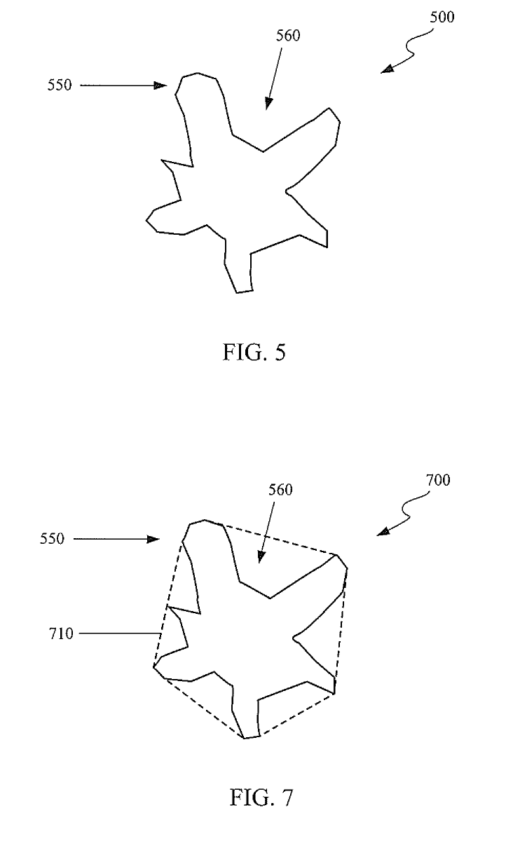

Useful solid particles have a shape that includes both convex and concave regions (also known as niches). FIG. 5 shows a solid particle 500 that includes convex regions 550 and concave regions 560. The solid particle of FIG. 5 has four convex regions and four concave regions. Other solid particles can have fewer such regions or more such regions. Concavity is a calculated value based on the solid particle's volume (Vp) compared to the volume of the solid particle's three-dimensional convex hull (Vh). The three-dimensional convex hull of a solid particle is defined as the smallest convex polyhedron such that for any two points on the surface of the solid particle, the line segment connecting these two points falls inside the convex polyhedron. Concavity is 1-(Vp/Vh). However, concavity is difficult to measure in practice. An estimate of concavity can be obtained based on the projection of a solid particle onto a plane. FIG. 7 shows a particle 700 having convex regions and concave regions. The projection of the solid particle onto a plane is shown at 710. The area of the projection (Ap) of the particle is compared to the area of the two-dimensional convex hull (Ah). The two-dimensional convex hull is defined similar to the three-dimensional hull. The estimated concavity is 1-(Ap/Ah). Particles should have an estimated concavity greater than approximately 0.1.

It has been discovered that when the particle shape and size satisfy the disclosed criteria, maximum porosity can be achieved in the final dried topcoat.

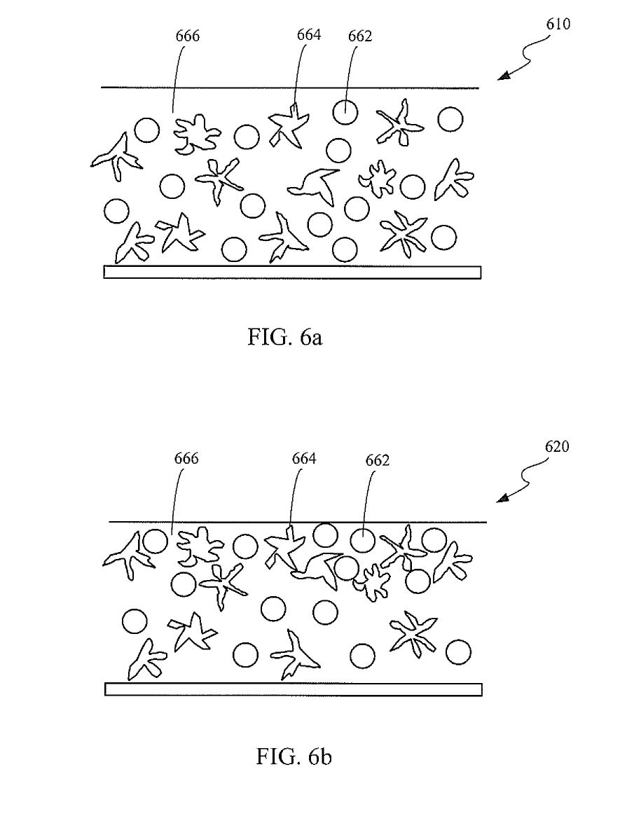

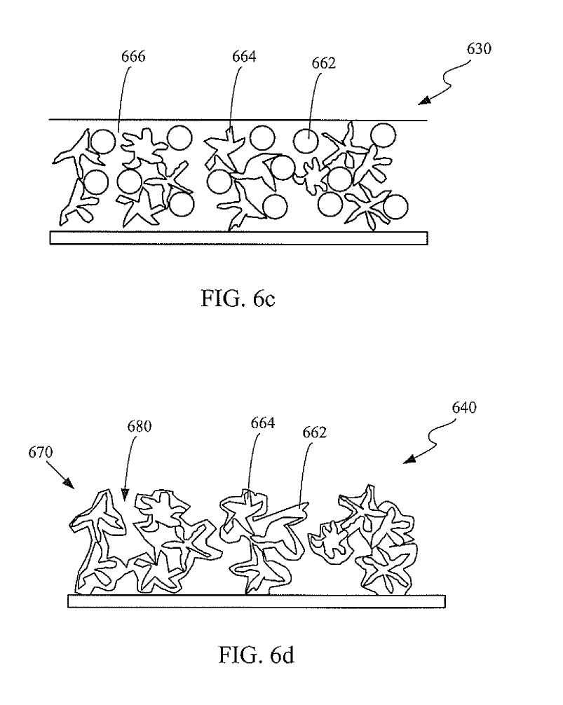

Without wishing to be bound by any particular theory, it is believed that when drying a polymer suspension, the binder particles go through four phases: suspension, consolidation, compaction, and fusion. FIGS. 6a to 6d illustrate the four phases for a coating formulation of the current invention. The coating formulation includes binder particles 662, solid particles 664, suspending solvent 666, and a substrate 604. In the first phase, as shown at 610 in FIG. 6a, both the binder particles and the solid particles are suspended by the suspending solvent and not bound to one another permanently. In the second phase, as shown at 620 in FIG. 6b, binder particles and solid particles start to touch as the suspending solvent evaporates. In the compaction phase, as shown at 630 in FIG. 6c, the particles are in permanent contact and are deformed by capillary action as more evaporation occurs. Due to the presence of the solid particles, full compaction of binder particles cannot occur. In the fusion stage, as shown at 640 in FIG. 6d, the binder particles fuse together. As the solid particles have a shape including convex and concave regions, and the solid particle's estimated concavity is greater than approximately 0.1, the solid particles will act as spacers to separate the binder particles in the compaction and fusion phases. The binder particles will compact toward the concave regions between solid particles, but still yield a porous topcoat with pores 680 distributed throughout the coating layer 670. In contrast, a polymer suspension without the desired type of solids will make a fully compacted, non-porous film.

The topcoat can be tailored to have porosities from approximately 0.2 to approximately 0.6. Porosity is the fractional volume of voids or pores compared to the total volume. The porosity can be increased by: a) reducing the amount of binder; b) selecting binder polymer dispersions and solid particles of similar size; c) selecting narrower size distributions over wider size distributions of binder polymer dispersions and solid particles; d) selecting solid particles which are spiked, or of a similar shape that provide a combination of convexities and concavities, so that the binder recedes at least partially into these concavities during the compaction stage of the topcoat drying; e) dispersing the solid particles with polyelectrolytes to increase their average distances in the consolidation stage of the topcoat drying.

Reducing the amount of binder, or alternatively increasing the amount of solid particles, in the formulation will increase porosity, but can lead to cracking of the coating when the binder to solid ratio is too low. In some embodiments, the volume ratio of binder particles to solid particles is from approximately 0.9 to approximately 1.25 and solid particles constitute approximately 55% to approximately 75% by weight of the total dried coating formulation, and the binder makes up approximately 25% to approximately 45% by weight of the total dried coating formulation.

The binder composition can be selected to deliver flexibility, increased adhesion to specific substrates, and improved thermal resistance by controlling the thickness, crosslinking density, selection of materials based on desired properties, and other physical properties, for example, glass transition temperature, or surface treatment. The composition can be tailored to create topcoats that are printable with both ink jet and laser printers, and also writable by a variety of writing instruments such as ballpoint pens, gel pens, highlighters, markers, and pencils. The topcoat created this way has CIE L* of 0.96 or higher in the CIE L*a*b* color space. It is believed the high L* value is a result of both the presence of the solid particles and also due to strong light dispersion from the pores.

The solid particles can be organic or inorganic particles. Suitable inorganic particles include, for example, calcium carbonate, titanium dioxide, silica, alumina, zinc sulfide, zinc oxide, antimony oxide, barium sulfate. Organic particles that satisfy the described shape and size criteria can also be used. Such organic particles include, for example, polyolefin, polyamide, polyester, and polyurethane particles. Any other organic or inorganic particles that have the correct estimated concavity can also be used.

In some embodiments, precipitated calcium carbonate (PCC) with a rosette shape was used as the solid particles in the coating formulation. The average diameter size of the PCC particles can range from approximately 0.1 micron to approximately 3 microns.

The binder can be a thermoplastic polymer that is delivered as a water-based suspension or colloidal suspension (often called “emulsion”) and may include, for example, poly(vinyl acetate) polymers, ethylene-vinyl acetate copolymers, ethylene-acrylic acid copolymers, polyacrylates, polyamides, polyesters, polyurethanes, and mixtures thereof. Other thermoplastic polymer suspensions may be found to be useful. When cationic polymers are added to the coating formulation to improve dye retention, binder emulsions that are stabilized by cationic or non-ionic mechanisms can be used. Examples of such binder materials include, for example, polyvinyl alcohol-stabilized emulsions of ethylene-vinyl acetate polymers, such as AIRFLEX 124, 125 and 144 (Air Products & Chemicals, Inc., Allentown, Pa.), cationic polyurethanes, such as WITCOBOND W-213 (Chemtura Corporation, Middlebury, Conn.), and cationic polyamides, such as AMRES 8855, 8870, C12, C20, C25, PR-335CU, and PR-247HV (Georgia Pacific Resins, Inc., Crosett, Ariz.). In one embodiment of the invention, a polyurethane emulsion that is free of ethylene oxide segments is stabilized with internal anionic and external nonionic species. A polyurethane of this type is sold under the name HYDROSIZE U2-01 (Michelman, Inc., Cincinnati, Ohio).

Crosslinkers can be added to the topcoat formulation to crosslink the binder materials. Crosslinkers that react with functional groups on the binder will work. Suitable crosslinkers include, for example, aziridine-based crosslinker such as CROSSLINKER CX-100 (DSM Neoresins B. V., Waalwijk, The Netherlands); polyaziridine-based crosslinkers such as XL-706 (STAHL International B. V., Waalwijk, The Netherlands) and PZ-28 and PZ-33 (Polyaziridine LLC, Medford, N.J.); isocyanate-based ECCO CROSSLINKER AP-900 (Eastern Color and Chemical Co., Providence, R.I.); silane-based crosslinkers such as the DYNASILANE series of products (Evonik Industries, Mobile, Ala.); metallic chelate compounds such as the TYZOR series of products such as TYZOR 131 (DuPont, Inc., Wilmington, Del.); polyol-based crosslinkers such as the POLY-G series of products (Arch Chemicals, Inc., Norwalk, Conn.); and amine-based crosslinkers such as VERSAMINE EH-50 (Cognis Deutschland GmbH & Co. KG., Dusseldorf, Germany). In one embodiment of the invention, CARBODILITE E-02 (Nisshinbo Industries Inc., Tokyo, Japan) is used. Typically, the crosslinkers are added at approximately 1% to approximately 2% on the dried weight basis.

Polyelectrolytes can be added to the formulation to improve the dispersion of the solid and binder particles. Both water-soluble and water-insoluble cationic polymers can be formulated as a dispersion or emulsion and used as a polyelectrolyte. Useful cationic polymers include, for example, amide-epichlorohydrin polymers, polyacrylamides with cationic moieties, polyethylimines, and polydiallylamines. Water-soluble polymers include, for example, poly (diallyldimethylammonium chloride) (PDDA), poly (2-hydroxy-3-methacryloxypropyl trimethylammonium chloride), and poly (butylacrylate-methacryloxyethyl trimethylammonium bromide). Water-insoluble polymers include, for example, quaternary acrylic copolymers like SYNTRAN HX31-65 trimethyl aminoethyl methacrylate/methyl methacrylate and SYNTRAN HX31-44 1-methoxy-2-propanol acrylate copolymer (Interpolymer Corp., Canton, Mass.); cationic modified ethylene-acrylic acid emulsions, such as MICHEM EMULSION 09625 (Michelman, Inc., Cincinnati, Ohio); cationic polyethylene emulsions, such as MICHEM EMULSION 09730 (Michelman, Inc., Cincinnati, Ohio); and cationic shell styrene-acrylate copolymer latexes, such as BASOPLAST 265D (BASF Corporation, Charlotte, N.C.). Cationic polyelectrolytes with quaternary ammonia polyelectrolytes can be selected to facilitate the fixing of ink jet dyes. In one embodiment of the invention, poly (diallyldimethylammonium chloride) is used. The polyelectrolytes are added at approximately 0.5% to approximately 2% on the dried weight basis.

Without limitation, other additives, for example, surfactants, UV stabilizers, defoamers, optical brighteners, dispersants, wetting agents, viscosity modifiers, pigments, dyes known to those skilled in the art can be added to the topcoat formulation.

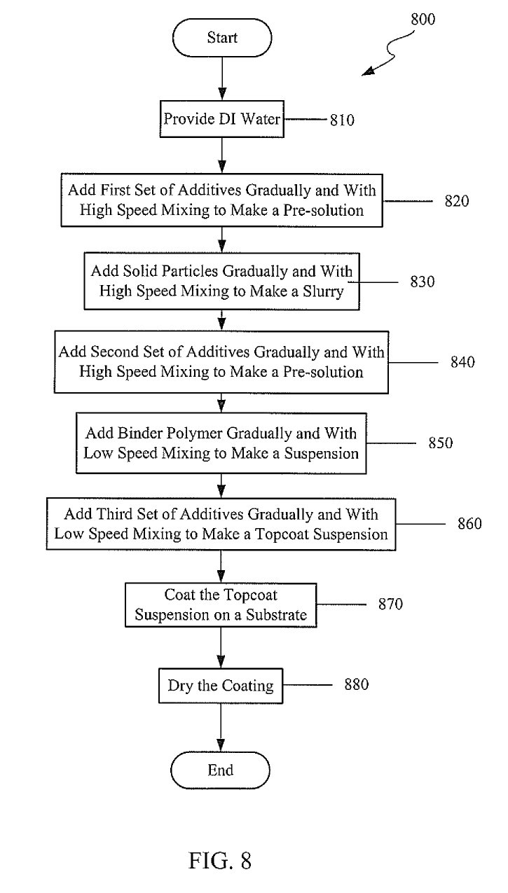

The topcoats herein disclosed can be made in any process known to one skilled in the art. A method of making topcoats according to one embodiment is illustrated at 800 in FIG. 8. Deionized water (DI water) is provided in a mixing container at step 810. A first set of additives, for example, defoamers, polyelectrolytes, dispersants, optical brighteners, wetting agents, etc., is added to the DI water with high-speed mixing at step 820 to make a pre-solution. Solid particles are then gradually added to the pre-solution with high-speed mixing to make a slurry at step 830. A second set of additives, for example, stabilizers, is added at step 840. The binder polymer is added into the slurry gradually, at a low-speed of mixing, to make a suspension at step 850. A third set of additives, for example, crosslinkers, can be added, if needed, at a low-speed of mixing to make the topcoat suspension at step 860. The topcoat suspension can then be coated onto a substrate at step 870, followed by drying at step 880. Any suitable coating method known to those skilled in the art can be used to coat the topcoat suspension onto the substrate, for example, die coating, slot die coating, curtain coating, wire coating, roll coating, rod coating, gravure coating, extrusion, and printing. In one embodiment of the invention, the thickness of the dried topcoat is approximately 25 microns to 60 microns.

The topcoat can be used as a layer in any application that requires an opaque appearance and writable or printable surface. In one embodiment of the invention, the topcoat is coated onto a substrate to make a label sheet.

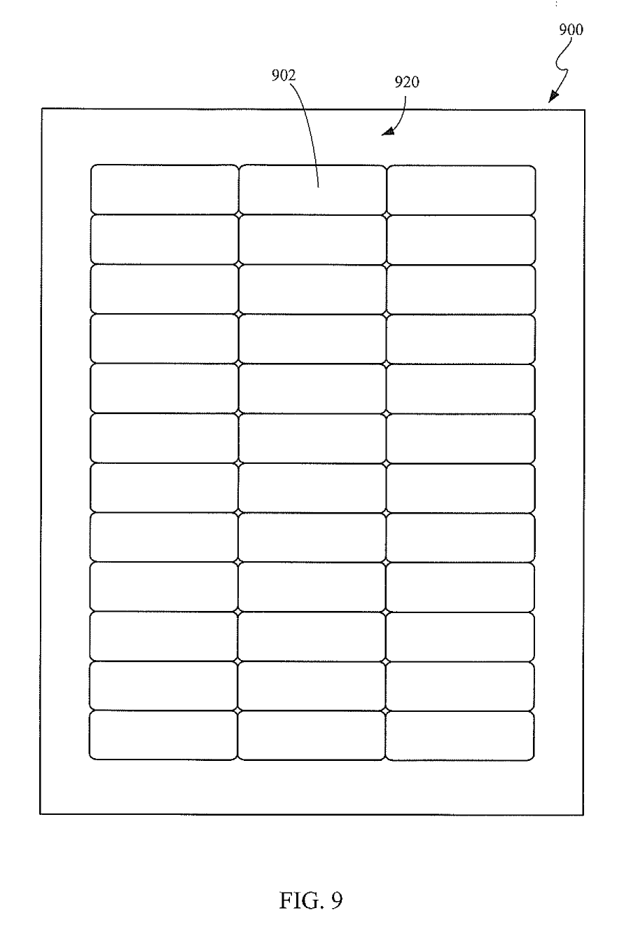

FIG. 9 shows a top plan view of an embodiment of a label sheet 900. The label sheet includes a substrate 204, a pressure sensitive adhesive 206, and a release liner 208 (see FIG. 2). The substrate is coated on the outer surface 904 with the topcoat 202. Labels 902 are cut into the substrate and topcoat using processes known to those skilled in the art.

In one embodiment of the invention, a label sheet 900 is made using a solid substrate 204, for example, paper or film, and laminating or coating each layer 202, 206 onto the substrate. In another embodiment, the label sheet is made using multilayer coating technology. A topcoat suspension, a suitable material for forming the substrate layer, and an adhesive layer are coated simultaneously onto a release liner. Drying and curing the multilayer coating results in the formation of the label sheet. The suitable substrate materials include, for example, crosslinkable vinyl acetate copolymers, vinyl acetate ethylene emulsions, polyurethane emulsions, or the mixtures thereof.

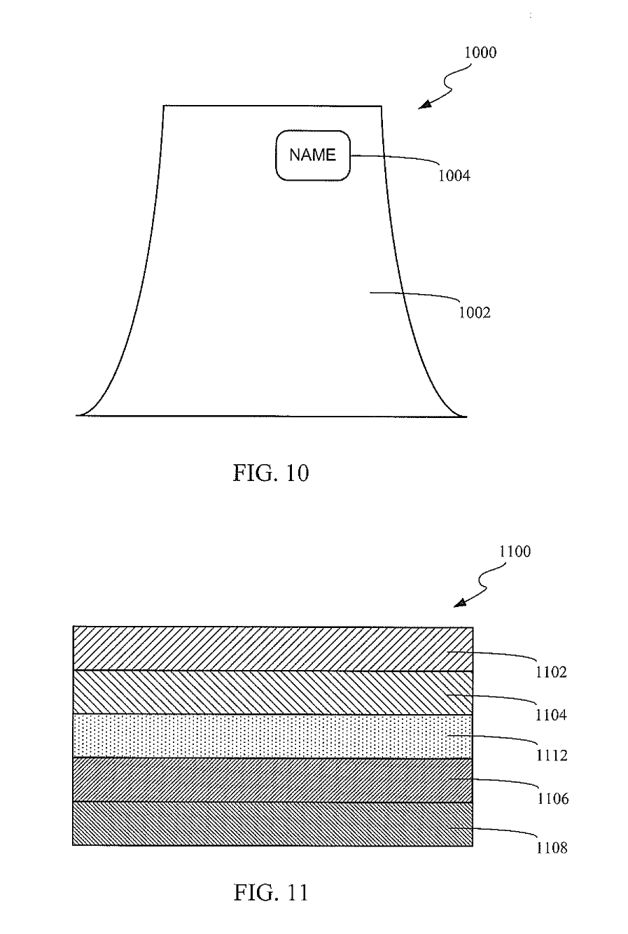

In another embodiment of the invention, a flexible name badge 1004 is made and applied to a fabric 1002 as shown in FIG. 10. The name badge includes a flexible substrate 204, a layer of the topcoat 202, and a pressure sensitive adhesive 206 (see FIG. 2). Generally, the name badge is supplied to a user with a release liner 208 covering the adhesive. The name badge is removed from the release liner prior to application to the fabric. The name badge is made in the same manner as the above described label sheet 900.

It is believed that lack of flexibility of the name badge 1004 can cause premature separation of the badge from a fabric 1002 to which it is applied. Since most fabrics are very flexible, a name badge that is not as flexible will experience stress after application to the fabric when fabric surrounding the badge flexes. The stress can cause the label to lift from the fabric near the edges and eventually fall off. A flexible name badge created using the above disclosed topcoat, in combination with a flexible substrate and pressure sensitive adhesive remains attached to the fabric without the topcoat cracking of flaking off during flexing of the fabric. Flexible thermoplastic polymers, for example, polyamides, polyesters, polyurethanes, polysiloxanes, and silicones, can be used as a suitable substrate. For a given substrate, adhesives can be selected based on the flexibility of the substrate to provide the desired adhesion and yet not so strong as to cause fabric damage or leave residue upon removal. In an embodiment of the invention, a clear polyethylene terephthalate (PET) sold under the name HOSTAPHAN 2261N (Mitsubishi Polyester Film, Inc., Greer, S.C.) is used as the substrate. The PET can be from approximately 0.5 mil to approximately 2.0 mils thick

The flexible name badge can be created with the following process: coat the topcoat prepared using the disclosed process as previously discussed or any other suitable process onto the substrate; in a separate process, coat a pressure sensitive adhesive onto a release liner; laminate the substrate with the pressure sensitive adhesive so that the topcoat faces away from the adhesive. The finished laminated product can then be cut into the desired shape and size for customers use. A primer layer can be coated on the adhesive side of the substrate to improve adhesion of the adhesive to the substrate. FIG. 11 is a cross sectional view of such a construction 1100. It includes a topcoat 1102, a substrate 1104, a primer layer 1112, an adhesive layer 1106, and a release liner 1108. In one embodiment of the invention, a primer coating sold as DEV-5124 (Avery Dennison, Corp., Pasadena, Calif.) was used. The primer layer has a coat weight of approximately 4 grams per square meter (gsm).

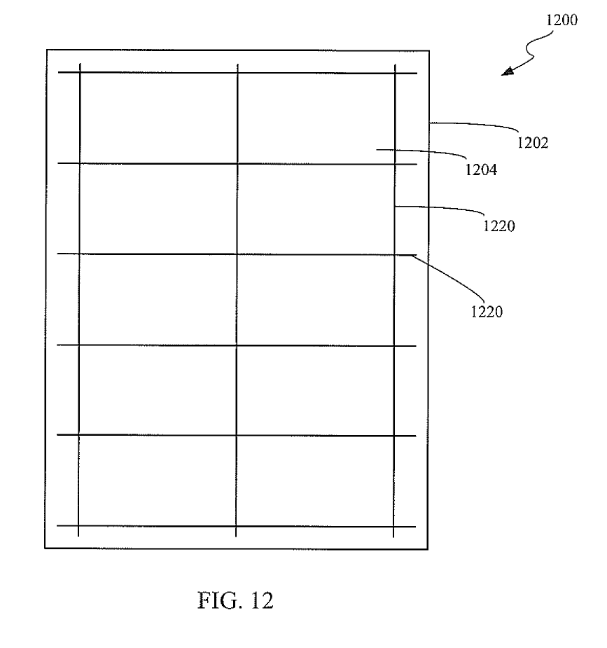

The disclosed topcoating can be used in yet another embodiment to make printable media that is easily separated by breaking. Such printable media includes, for example, calling cards, gift cards, credit cards, photographic media, and business cards. U.S. Pat. No. 7,514,134 to Utz, et al., discloses printable media that is separated by breaking and is incorporated by reference herein in its entirety. Avery Dennison Corp. of Pasadena, Calif., identifies several breakable card products as CLEAN EDGE products. In one embodiment of the present invention, polycarbonate film is used. Suitable polycarbonates include, for example, LEXAN 8010 (SABIC Innovative Plastics, Inc., Pittsfield, Mass.) and PC-811 (Mianyang Longhua Film Co., Yongxing Industrial Development Zone Mianyang Sichuan, China). These polycarbonate films have a glass transition temperature of approximately 153° Celsius and can easily withstand laser printing and xerographic copying operations without deforming or melting. Die-cutting can be conducted to cut from one surface of the polycarbonate film and extend partially but not completely through the film. The cutting operation creates weakened lines in the film, along which the film easily and cleanly breaks upon folding outwardly (away from the cutting surface) and inwardly. In spite of the weakened cut lines, the film is strong enough to maintain its integrity during handling and further processing. The thickness of the polycarbonate film can range from approximately 1 mil to approximately 20 mils. In some embodiments, the thickness of the polycarbonate film ranges from approximately 3 mils to approximately 10 mils. When the polycarbonate film thickness is less than approximately 5 mils, the film is flexible and remains flexible even after the topcoat is applied to both surfaces of the polycarbonate film. Flexible films are suited for applications that need good conformability. On the other hand, when thicker polycarbonate film is used, for example greater than approximately 7 mils thick, the coated film is more rigid and suitable for applications as business cards and credit cards, for example. The topcoat can be coated onto one or both sides of the polycarbonate substrate. FIG. 12 illustrates a sheet of business cards 1200 which includes topcoated polymer substrate 1202 and weakened lines 1220 between each business card 1204.

Test Methods

Marker Friction and Drag Test

To determine the amount of frictional force a user experiences when writing on a writable media with a writing instrument, an MASS SP-2000 Slip/Peel Tester (Instrumentors Inc., Strongsville, Ohio) was used. The tester includes three holders with clamps for securing writing instruments, a movable platen to hold the media, and a load cell for the force measurement. Three markers of the same type and brand are clamped in the holders such that the clamp is 1.3 mm from the tip of the marker. The marker holder is attached to the load cell and the media is taped in place onto the platen. The moving plate is then programmed to move at the desired speed. The force recorded by the load cell is divided by three to obtain the frictional force per marker. The same substrate without the topcoat is used to check on the markers after each pass. If the values differ more than 5 grams, the markers are assumed to have been damaged and are to be replaced. The test is repeated with an additional weight of 200 grams and 500 grams.

Scratch Resistance

To test the amount of force needed to scratch the coating from a substrate, a scratch test was performed on the TABER Linear Abraser model 5750 (Taber Industries, North Tonawanda, N.Y.). The machine is set to 5 cycles at 30 cycles per minute. The scratch test is performed with a 1.0 mm diameter hemispherical stylus and 94 grams of weight. If the coating shows visible signs of being scratched after 5 cycles, the test is repeated with additional weight added to the stylus. If the sample shows visible signs of being scratched at 94 grams, the weight is reduced to 49.6 grams, the lowest possible weight. The scratch test is repeated with 49.6 grams, increasing the weight until the coating shows signs of being scratched. The weight recorded is the largest amount of weight before the coating shows signs of being scratched.

Permanent Marker Writability

The coated substrate is written upon with SHARPIE ULTRA FINE POINT and SHARPIE FINE POINT (Sanford L. P., Oak Brook, Ill.) permanent black markers. The products were rated based on image text quality and drag of writing. Severe is considered poor image quality with excessive drop-outs or voids, excessive bleed or widening of draw lines and high drag values. Excellent is considered high quality images that have lines without bleed or drop-outs and low drag values. Ratings were based on a 0-4 scale, with 0 being severe and 4 being excellent.

Thickness

Thickness of substrates and topcoated materials is measured with a thickness tester, PROGAGE part # 89-2004 rev01 (Thwing-Albert Instalment Co., Philadelphia, Pa.). Reported values are the average of at least 5 repetitions.

Porosity

Porosity is measured using a PROFILER/PLUS ROUGHNESS AND POROSITY instrument (Technidyne Corporation, New Albany, Ind.). The test method used is the Technical Association of the Pulp and Paper Industry (TAPPI) test method T547 om-02 entitled: Air Permeance of Paper and Paperboard (Sheffield method).

Opacity

Opacity was measured using COLOR I5 Benchtop Spectrophotometer (X-Rite, Inc., Grand Rapids, Mich.). The test method is TAPPI T425 om-01 entitled: Opacity of Paper.

90 Degree Peel From Topcoat

A LAB MASTER RELEASE AND ADHESION 80-91 machine (Testing Machines Inc., Ronkonkoma, N.Y.) is used for this test. The coated sample is fixed, coated side up, onto the sample platform using a double side tape FT530 (Avery Dennison, Pasadena, Calif. with the SCOTCH 810 MAGIC TAPE (3M Company, St. Paul, Minn.) is then laminated onto the coated surface, such that the tape extends over the end of the coated surface by 2 inches. A 4 pound handheld roller is rolled over the tape-sample laminate twice. The extended portion of the tape is then fixed onto the clamp of the test machine. The tape is peeled at the specified rate at 90 degree angle and the peel force is recorded. The test sample is examined for the amount of coating remaining on the substrate after the peel test. Peel rates used include 12, 150, 300, 600, and 1200 inches per minute.

90 Degree Peel From Adhesive

The 90 degree peel adhesion using a stainless steel test substrate was conducted using an INSTRON 4301 (Illinois Tool Works Inc., Norwood, Mass.). The test method is conducted according to Pressure Sensitive Tape Council (PSTC) Test Methods (12th edition) Appendages A and D.

CIE L*a*b* Color Space

This test is used to describe the color of the topcoat. This 3-dimensional color space system was developed by the International Commission on Illumination (CIE), and defines L* as representing the lightness of the color, ranging from 0 (black) to 100 (white). In this system, a* represents the color's position along the red (magenta)/green axis, in which negative values represent green and positive values represent red or magenta), and b* represents the color's position along the blue/yellow axis, in which negative values represent blue and positive values represent yellow. The test is conducted using a COLOR I5 Benchtop Spectrophotometer (X-Rite, Inc., Grand Rapids, Mich.). The test method is TAPPI T524 om-94.

Loop Tack on Stainless Steel

The 90 degree loop tack test on stainless steel is conducted using an INSTRON 4301 (Illinois Tool Works Inc., Norwood, Mass.). The test method is conducted according to PSTC Test Methods (12th edition) Test Method 5.

Cross-Hatch Adhesion Test

This test is performed according to ASTM D3359. The topcoat surface is first cut into a grid of 100 squares using a razor blade. SCOTCH 810 MAGIC TAPE is applied over the cross-hatched area and smoothed out using finger pressure with no wrinkles or bubbles. The tape is peeled off rapidly at an angle of 180 degrees. The number of squares that remain on the topcoat surface provides a relative value of adhesion.

Topcoat Examples

Materials used in the topcoat examples are listed in Table 1. Also in Table 1 is the source of each material. Table 2 provides the formulation for each of the topcoat examples discussed.

TABLE 1

| Material | Function Description | Supplier | Location |
|---|---|---|---|
| Albacar 5970 | Filler, PCC, rosette shape 1.9 microns | Speciality Minerals, Inc. | New York, NY |
| Byk 347 | Surface wetting; silicone surfactant | Byk USA Inc. | Wallingford, CT |
| Byk E420 | supension stabilizer; thixotropic agent | Byk USA Inc. | Wallingford, CT |
| Carbodilite E-02 | crosslinker, polycarbodiimide | Nisshimbo Industries, Inc | Japan |
| Dehydran 1620 | Defoamer; modified alchohols & | Cognis Corporation | Cincinnati, OH |
| | polysiloxane adduct | | |
| Dehydran 2620 | Defoamer; modified alchohols & | Cognis Corporation | Cincinnati, OH |
| | polysiloxane adduct | | |
| Disperbik 185 | Dispersant & wetting agent, high MW | Byk USA Inc. | Wallingford, CT |
| Dow Corning | Water-based silicone antifoam | Dow Corning Corporation | Midland, Michigan |
| 62 Additive | | | |
| Hostaphan 2261N | PET clear film | Mitsubishi Polyesther | Greer, SC |
| | | Film, Inc. | |
| BYK 028 | defoamer | Byk USA Inc. | Wallingford, CT |
| PDDA | Cationic polyelectrolyte | Sigma-Aldrich | Saint Louis MO |
| Tinopal SFP | Optical brightener | Ciba Speciality | Tarrytown, NY |
| | | Chemicals Corporation | |
| Ti-Pure R931 | Pigment, TiO2 | Dupont Titanium | Wilmington, DE |
| | | Technologies | |
| Tyzor 131 | Adhesion promoter, Organic Titanate | Dupont | Wilmington, DE |
| U2-01 | binder, PU dispersion 1.3-1.5 microns | Michelman, Inc. | Cincinnati, OH |
| Dispal 14N4-080 | dispersibie alumina | Sasol Nother America, Inc. | Houston, TX |
| PP2114 | functionalized polypropylene | Michelman, Inc. | Cincinnati, OH |
| | colloidal dispersion | | |
| U1-01 | binder, PU dispersion | Michelman, Inc. | Cincinnati, OH |
| AE-3349 | adhesive | Avery Dennison | Pasadena, CA |
| AE-3497THA | adhesive | Avery Dennison | Pasadena, CA |
| AE-3413 | adhesive | Avery Dennison | Pasadena, CA |
| AIRFLEX 600BP | adhesive | Wacker Polymers | Pennsylvania |
| AE-5151 | adhesive | Avery Dennison | Pasadena, CA |
| AS-8023 | adhesive | Avery Dennison | Pasadena, CA |
| AROSET APS 1133 | adhesive | Ashland | Covington, KY |

TABLE 2

| | Sequency | | | | | | | |
|---|---|---|---|---|---|---|---|---|
| | | 2 | | | | | | |
| | | Dow | | | | 6 | | |
| | 1 | Corning | 3 | 4 | | Dispal | 7 | 8 |
| Formulation | Water | 62 | BYK | Disperbik | 5 | 14N4- | Albacar | Ti-Pure |
| (kg) | (Deionized) | additive | 028 | 185 | PDDA | 080 | 5970 | R931 |
| Form. #1 | 2.326 | 0.004 | 0.000 | 0.014 | 0.081 | 0.000 | 1.360 | 0.000 |
| Form. #2 | 2.233 | 0.000 | 0.000 | 0.014 | 0.095 | 0.000 | 1.424 | 0.000 |
| Form. #3 | 2.325 | 0.004 | 0.000 | 0.014 | 0.081 | 0.041 | 1.318 | 0.000 |
| Form. #4 | 2.137 | 0.000 | 0.000 | 0.000 | 0.154 | 0.000 | 1.484 | 0.000 |
| Form. #5 | 2.119 | 0.000 | 0.000 | 0.000 | 0.158 | 0.000 | 1.463 | 0.000 |
| Form. #6 | 2.127 | 0.000 | 0.000 | 0.000 | 0.170 | 0.000 | 1.223 | 0.259 |
| Form. #7 | 2.205 | 0.000 | 0.000 | 0.000 | 0.117 | 0.000 | 1.447 | 0.000 |
| Form. #8 | 2.188 | 0.000 | 0.000 | 0.000 | 0.120 | 0.000 | 1.426 | 0.000 |
| Form. #9 | 2.226 | 0.000 | 0.000 | 0.000 | 0.117 | 0.000 | 1.456 | 0.000 |
| Form. #10 | 2.209 | 0.000 | 0.000 | 0.000 | 0.121 | 0.000 | 1.435 | 0.000 |
| Form. #11 | 2.230 | 0.004 | 0.000 | 0.014 | 0.084 | 0.000 | 1.408 | 0.000 |
| Form. #12 | 2.238 | 0.000 | 0.010 | 0.011 | 0.081 | 0.000 | 1.394 | 0.000 |
| Form. #13 | 2.220 | 0.000 | 0.000 | 0.000 | 0.115 | 0.000 | 1.450 | 0.000 |

| | Sequency | | | | | | | | |
|---|---|---|---|---|---|---|---|---|---|
| | | | | | | 14 | | | |
| | 9 | 10 | 11 | | | Carbo- | 15 | 16 | 17 |
| Formulation | Tinopal | Byk | PP | 12 | 13 | dilite E- | Dehydran | Tyzor | Byk |
| (kg) | SFP | E420 | 2114 | U1-01 | U2-01 | 02 | 2620 | 131 | 347 |
| Form. #1 | 0.003 | 0.006 | 0.000 | 0.000 | 1.130 | 0.067 | 0.000 | 0.000 | 0.010 |
| Form. #2 | 0.004 | 0.000 | 0.000 | 0.000 | 1.158 | 0.068 | 0.003 | 0.000 | 0.000 |
| Form. #3 | 0.003 | 0.010 | 0.000 | 0.000 | 1.129 | 0.067 | 0.000 | 0.000 | 0.010 |
| Form. #4 | 0.000 | 0.000 | 0.000 | 0.000 | 1.157 | 0.069 | 0.000 | 0.000 | 0.000 |
| Form. #5 | 0.000 | 0.000 | 0.000 | 0.000 | 1.191 | 0.070 | 0.000 | 0.000 | 0.000 |
| Form. #6 | 0.000 | 0.000 | 0.000 | 0.000 | 1.154 | 0.068 | 0.000 | 0.000 | 0.000 |
| Form. #7 | 0.000 | 0.000 | 0.000 | 0.000 | 1.128 | 0.067 | 0.000 | 0.038 | 0.000 |
| Form. #8 | 0.000 | 0.000 | 0.000 | 0.000 | 1.160 | 0.069 | 0.000 | 0.039 | 0.000 |
| Form. #9 | 0.000 | 0.000 | 0.000 | 0.000 | 1.135 | 0.067 | 0.000 | 0.000 | 0.000 |
| Form. #10 | 0.000 | 0.000 | 0.000 | 0.000 | 1.168 | 0.069 | 0.000 | 0.000 | 0.000 |
| Form. #11 | 0.003 | 0.008 | 0.000 | 0.000 | 1.170 | 0.069 | 0.000 | 0.000 | 0.010 |
| Form. #12 | 0.003 | 0.006 | 0.183 | 0.787 | 0.245 | 0.032 | 0.000 | 0.000 | 0.010 |
| Form. #13 | 0.000 | 0.000 | 0.000 | 0.000 | 1.130 | 0.000 | 0.000 | 0.077 | 0.000 |

Topcoat formulation 1 is prepared in a 2 gallon plastic pail. A HEIDOLPH RZR 2102 (R. B. Radley Co. Ltd, Essex, United Kingdom) control mixer with a radial dissolver blade R1302 (IKA Works Inc., Wilmington, N.C.) is used for the mixing. DI water is first added to the pail. The mixer is operated at 1000 rpm while the DOW CORNING 62 ADDITIVE is added. The mixer is kept operating for 5 minutes before additional components are added. The same mixing speed and time is used for adding DISPERBYK 185. Next, PDDA is added at the same mixing rate and the mixer is mixed for 15 minutes. The mixing speed is increased to 1400 rpm, and ALBACAR 5970 is added gradually over 5 minutes. CIBA TINOPAL SFP is added next at the same mixing rate. The mixer is stirred at 1400 rpm for 1 hour. BYK E420 is added and the mixture mixed for 30 minutes at the same speed. The mixing speed is then lowered to 500 rpm. HYDROSIZE U2-01 is added and the mixer operated for 5 minutes. Carbodilite E-02TM and BYK 347 are then added sequentially with 5 minutes of mixing after the addition of each. The mixer is kept operating at 500 rpm for 30 minutes and then turned off. The mixture is held at ambient conditions for 24 hours to degas.

Topcoat formulation examples 2-13 are made with the same process as topcoat formulation example 1 according to the amounts listed in Table 2. Components listed with sequence numbers 1 to 5 are added at 1000 rpm, those listed with sequence numbers 6 to 10 are added at 1400 rpm, and those listed with sequence numbers 11 to 17 are added at 500 rpm.

Topcoat formulations 1-13 can be coated onto 92 gauge clear PET HOSTAPHAN 2261N (Mitsubishi Polyester Film, Inc., Greer, S.C.) with a dried film thickness of about 50 microns. They can also be coated successfully onto 3 mils, white extruded polyurethane, DUREFLEX (Deerfield Urethane a Bayer Material Science Company, Pittsburgh, Pa.), and onto co-extruded EVA-LDPP (low density polypropylene) films, EVA-LDPE films, and modified EVA films, and paper. Additionally, topcoat formulation 12 can be coated onto PRIMAX 250 (Avery Dennison Corporation, Pasadena, Calif.), an extruded 2.5 mils thick EVA/PP coextruded film.

Coating Examples

Table 3 summarizes of the properties of opacity, CIE L*a*b* color space, writability and scratch resistance for some illustrative coated samples. The coating formulation and thickness, as well as measured porosity are also shown for the coated samples. All examples were coated onto 92 gauge clear PET HOSTAPHAN 2261N, and dried at 120 C for 3 minutes.

TABLE 3

| | | Property | | | | | | | | |
|---|---|---|---|---|---|---|---|---|---|---|
| Coated | | | | | | | | | writability- | scratch |
| Example | Formulation | thickness | | Opacity | CIE L* a* b* | | | writability- | sharpie ultra | resistance |
| No. | No. | um | porosity | % | L* | a* | b* | sharpie fine | fine | g |
| 1 | 4 | 51.8 | 0.43 | 87.51 | 96.16 | 0.003 | −0.29 | 2 | 2 | 100 |
| 2 | 5 | 49.4 | 0.39 | 87.77 | 96.18 | 0.027 | −0.03 | 3 | 2 | 125 |
| 3 | 6 | 45.8 | 0.32 | 92.53 | 96.61 | −0.397 | 1.15 | 2 | 2 | 135 |
| 4 | 7 | 51.0 | 0.39 | 89.75 | 96.06 | −0.05 | 0.06 | 3 | 1 | 135 |
| 5 | 8 | 49.2 | 0.39 | 87.79 | 96.14 | −0.01 | 0.48 | 3 | 2 | 135 |
| 6 | 9 | 49.6 | 0.41 | 88.95 | 96.17 | −0.045 | −0.13 | 3 | 3 | 165 |
| 7 | 10 | 48.9 | 0.38 | 88.53 | 96.075 | −0.035 | −0.17 | 3 | 1 | 135 |
| 8 | 6 | 36.6 | | 90.91 | 96.38 | −0.350 | 1.21 | | | |
| 9 | 6 | 32.5 | | 90.01 | 96.17 | −0.357 | 1.20 | 3 | 2 | 85 |

All examples measured have porosity values over 0.30 and opacity values greater than 87%. The CIE L*a*b* values of the coated substrates show that L* is greater than 96, indicating high luminosity, with a* close to 0 or slightly negative (slightly greenish), and b* slightly negative to positive (slightly blue to yellowish. The writability test shows most coatings can be written upon with a SHARPIE FINE MARKER. Most of the examples withstand scratch resistance of greater than 100 g.

Table 4 summarizes the 90 degree peel results of the coated examples. It is clear that the topcoat has good adhesion to the SCOTCH 810 MAGIC TAPE, shown by high peel force, and also has strong anchorage to the PET substrate, shown by the clean separation with no coating transferred to the tape. On the other hand, a control sample, 3M POST-IT 2800-M (3M Company, St. Paul, Minn.), showed coating being transferred to the tape.

TABLE 4

| | | Peel Rate | | | | | | | | |
|---|---|---|---|---|---|---|---|---|---|---|
| | | 12 ipm | | | 150 ipm | | | 300 ipm | | |
| | | | Coating | | | Coating | | | Coating | |
| | | | Transferred | | | Transferred | | | Transferred | |
| Coated | | Av. | to testing | | Av. | to testing | | Av. | to testing | |
| Example | Formulation | Force | tape | | Force | tape | | Force | tape | |
| No. | No. | (g) | % | Comments | (g) | % | Comments | (g) | % | Comments |
| Control | | 714 | 100 | Halfway | 509 | 99 | Halfway | 483 | 99 | Halfway |
| | | | | separation | | | separation | | | separation |
| 1 | 4 | 515 | 0 | Smooth, no | 658 | 0 | Smooth, no | 791 | 0 | Smooth, no |
| | | | | separation | | | separation | | | separation |
| 2 | 5 | 530 | 0 | Smooth, no | 700 | 0 | Smooth, no | 810 | 0 | Smooth, no |
| | | | | separation | | | separation | | | separation |
| 3 | 6 | 524 | 0 | Smooth, no | 818 | 0 | Smooth, no | 838 | 0 | Smooth, no |
| | | | | separation | | | separation | | | separation |
| 4 | 7 | 480 | 0 | Smooth, no | 667 | 0 | Smooth, no | 624 | 0 | Smooth, no |
| | | | | separation | | | separation | | | separation |
| 5 | 8 | 467 | 0 | Smooth, no | 682 | 0 | Smooth, no | 747 | 0 | Smooth, no |
| | | | | separation | | | separation | | | separation |
| 6 | 9 | 503 | 0 | Smooth, no | 729 | 0 | Smooth, no | 809 | 0 | Smooth, no |
| | | | | separation | | | separation | | | separation |
| 7 | 10 | 497 | 0 | Smooth, no | 744 | 0 | Smooth, no | 853 | 0 | Smooth, no |
| | | | | separation | | | separation | | | separation |
| 8 | 6 | 528 | 0 | Smooth, no | 821 | 0 | Smooth, no | 831 | 0 | Smooth, no |
| | | | | separation | | | separation | | | separation |
| 9 | 6 | 526 | 0 | Smooth, no | 734 | 0 | Smooth, no | 828 | 0 | Smooth, no |
| | | | | separation | | | separation | | | separation |

| | | Peel Rate | | | | | |
|---|---|---|---|---|---|---|---|
| | | 600 ipm | | | 1200 ipm | | |
| | | | Coating | | | Coating | |
| | | | Transferred | | | Transferred | |
| Coated | | Av. | to testing | | Av. | to testing | |
| Example | Formulation | Force | tape | | Force | tape | |
| No. | No. | (g) | % | Comments | (g) | % | Comments |
| Control | | 393 | 100 | Halfway | 306 | 100 | Halfway |
| | | | | separation | | | separation |
| 1 | 4 | 897 | 0 | Smooth, no | 965 | 0 | Smooth, no |
| | | | | separation | | | separation |
| 2 | 5 | 911 | 0 | Smooth, no | 985 | 0 | Smooth, no |
| | | | | separation | | | separation |
| 3 | 6 | 934 | 0 | Smooth, no | 1018 | 0 | Smooth, no |
| | | | | separation | | | separation |
| 4 | 7 | 845 | 0 | Smooth, no | 907 | 12 | Partial |
| | | | | separation | | | separation in |
| | | | | | | | the middle |
| 5 | 8 | 881 | 0 | Smooth, no | 942 | 0 | Smooth, no |
| | | | | separation | | | separation |
| 6 | 9 | 941 | 0 | Smooth, no | 998 | 0 | Smooth, no |
| | | | | separation | | | separation |
| 7 | 10 | 937 | 0 | Smooth, no | 999 | 0 | Smooth, no |
| | | | | separation | | | separation |
| 8 | 6 | 936 | 0 | Smooth, no | 1005 | 0 | Smooth, no |
| | | | | separation | | | separation |
| 9 | 6 | 932 | 0 | Smooth, no | 1020 | 0 | Smooth, no |
| | | | | separation | | | separation |

Laminated Examples

Table 5 summarized the results a tape made using the topcoat formulation example 6 coated on 92 gauge clear PET HOSTAPHAN 2261N at 40 gsm coat weight and laminated with various adhesives at 12 gsm coat weight. The final tape has stiffness values of about 5.9 to 11.5 mN. The stiffness test is conducted using a 38.1 mm wide and 5 mm long strip and performing the test on a TESTING MACHINES MODEL #79-25-00-0003 (Testing Machines Inc., Ronkonkoma, N.Y.). Each label was applied to the various fabrics listed in Table 5 for 24 hours at 140 degrees F. Each label was peeled off each fabric, and the fabric was visually inspected for any adhesive residue or damage to the fabric. Adhesive AIRFLEX 600BP shows a balanced adhesion and peel performance, and also a broad applicability to various fabrics with minimal damage or residue on the fabric.

TABLE 5

| Laminated | | Loop | 90 Deg | | | | | |
|---|---|---|---|---|---|---|---|---|
| Example | Adhesive | Tack, SS | Peel, SS | satin | silk | 100% | leather | leather |
| No. | ID | (lb/in) | (lb/in) | (acetate) | (dupioni) | wool | (finished) | (unfinished) |
| 1 | AE-3349 | 4 | 2.0-tear | | | | fabric | fiber lift, |
| | | | | | | | damage | fabric |
| | | | | | | | | damage |
| 2 | AE- | 0.6 | 0.3 | | | light | | residue, |
| | 3497THA | | | | | adhesion | | fabric |
| | | | | | | | | damage |
| 3 | AE3413 | 2.5 | 2.2 | | | fiber lift | fabric | fiber lift, |
| | | | | | | | damage | fabric |
| | | | | | | | | damage |
| 4 | AIRFLEX | 1.1 | 0.3 | | | | fabric | fiber lift |
| | 600 BP | | | | | | damage | |
| 5 | AE-5151 | 1.5 | 1.8 | residue | residue | fiber lift | residue | |
| 6 | AS-8023 | NA | 0.7 | | | light | | |
| | | | | | | adhesion | | |
| 7 | AROSET | NA | 0.9 | | | light | | |
| | APS 1133 | | | | | adhesion | | |

| Laminated | | | | | | | |
|---|---|---|---|---|---|---|---|
| Example | | corduroy | 100% | | | | polyester |
| No. | velvet | (wide) | polyester | vinyl | cotton | 50/50 | sport |
| 1 | light | fiber lift, | | residue, | slight | fabric | fabric |
| | adhesion | fabric | | damage | impression | stretch, | stretch |
| | | damage | | | | slight | |
| | | | | | | impression | |
| 2 | light | | light | residue, | slight | slight | |
| | adhesion | | adhesion | damage | impression | impression | |
| 3 | light | fiber lift, | | residue, | | | |
| | adhesion | fabric | | damage | | | |
| | | damage | | | | | |
| 4 | light | fiber lift, | | residue, | | | |
| | adhesion | fabric | | damage | | | |
| | | damage | | | | | |
| 5 | light | residue | residue | | | | |
| | adhesion | | | | | | |
| 6 | light | light | light | | | | |
| | adhesion | adhesion | adhesion | | | | |
| 7 | light | light | light | | | | |
| | adhesion | adhesion | adhesion | | | | |

Business Card Example

Topcoat formulation 13 was first coated on the one surface of a 10 mil thick PC-811 film substrate (Mianyang Longhua Film Co., Yongxing Industrial Development Zone, Mianyang Sichuan, China) and dried at 130 C for 10 minutes. The dispersion was then coated on the other surface and dried again at 130 C for 10 minutes. The dry thickness of the coating is approximately 30 μm.

The coating was both ink jet and laser printable and can be written upon with a mechanical pencil. The coating also passed cross-hatch adhesion test conducted using SCOTCH MAGICTAPE 810. Partial die-cutting was performed from the top surface using a Lab Bench Die-Cutter. Cutting dies with clearances (uncut thickness) ranging from approximately 20 μm to 50 μm were tested. While the pristine PC-811 film (Mianyang Longhua Film Co., Yongxing Industrial Development Zone Mianyang Sichuan, China) film can be partially cut with all the dies and will separate cleanly upon folding outward and inward, the coated film separated pre-maturely after cutting using dies having clearance of approximately 30 μm or less. With higher clearances, the coated film maintained integrity, even after ink jet and laser printing, and separated cleanly upon folding outward and inward.

All of the features disclosed in the specification, including the claims, abstract, and drawings, and all of the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

The foregoing detailed description of the present invention is provided for purposes of illustration, and it is not intended to be exhaustive or to limit the invention to the particular embodiments disclosed. The embodiments may provide different capabilities and benefits, depending on the configuration used to implement the key features of the invention. Accordingly, the scope of the invention is defined only by the following claims.

We claim:

1. A coating composition comprising:
a solid material including particles having an estimated concavity; and
a binder material;
wherein:
the solid material and the binder material are in a water-based suspension; and
the estimated concavity of the solid material particles is greater than approximately 0.1.

2. The coating composition of claim 1, wherein the solid material is selected from the group consisting of calcium carbonate, precipitated calcium carbonate, titanium dioxide, silica, alumina, zinc sulfide, zinc oxide, antimony oxide, barium sulfate, polyolefin, polyamide, polyester, and polyurethane particles.

3. The coating composition of claim 1, wherein the binder material is selected from the group consisting of poly (vinyl acetate) polymers, ethylene-vinyl acetate copolymers, ethylene-acrylic acid copolymers, polyacrylates, polyamides, polyesters and polyurethanes.

4. The coating composition of claim 1, further comprising polyelectrolytes.

5. The coating composition of claim 4, wherein the polyelectrolytes are grafted onto one of the solid material and the binder material.

6. The coating composition of claim 1, wherein the solid material is approximately 55% to 75% of the weight of the composition when the coating composition is dried.

7. The coating composition of claim 1, wherein the binder material is approximately 25% to 45% of the weight of the composition when the coating composition is dried.

8. The coating composition of claim 1, wherein:
the solid material has a volume;
the binder material has a volume;
the ratio of the solid material volume to the binder material volume is approximately 0.9 to 1.25 when the coating composition is dried.

9. A method for manufacturing a coating composition, the method comprising:
providing a solid material;
providing a suspended binder;
dispersing the solid material to make a slurry; and
dispersing the suspended binder into the slurry;
wherein:
the solid material includes particles having an estimated concavity; and
the estimated concavity of the solid material particles is greater than approximately 0.1.

10. The method of claim 9, wherein the solid material is selected from the group consisting of calcium carbonate, precipitated calcium carbonate, titanium dioxide, silica, alumina, zinc sulfide, zinc oxide, antimony oxide, barium sulfate, polyolefin, polyamide, polyester, and polyurethane particles.

11. The method of claim 9, wherein the suspended binder material is selected from the group consisting of poly (vinyl acetate) polymers, ethylene-vinyl acetate copolymers, ethylene-acrylic acid copolymers, polyacrylates, polyamides, polyesters and polyurethanes.

12. The method of claim 9, wherein the solid material is approximately 55% to 75% of the weight of the composition when the coating composition is dried.

13. The method of claim 9, wherein the suspended binder material is approximately 25% to 45% of the weight of the composition when the coating composition is dried.

14. The method of claim 9, wherein:
the solid material has a volume;
the suspended binder material has a volume;
the ratio of the solid material volume to the suspended binder material volume is approximately 0.9 to 1.25 when the coating composition is dried.

15. A printable media comprising:
a substrate having a surface; and
a topcoat layer on the substrate surface;
wherein:
the topcoat layer includes a solid material, the solid material including particles having an estimated concavity;
the topcoat layer further including a binder material; and
the estimated concavity of the solid material is greater than approximately 0.1.

16. The printable media of claim 15, wherein the solid material is selected from the group consisting of calcium carbonate, precipitated calcium carbonate, titanium dioxide, silica, alumina, zinc sulfide, zinc oxide, antimony oxide, barium sulfate, polyolefin, polyamide, polyester, and polyurethane particles.

17. The printable media of claim 15, wherein the binder material is selected from the group consisting of poly (vinyl acetate) polymers, ethylene-vinyl acetate copolymers, ethylene-acrylic acid copolymers, polyacrylates, polyamides, polyesters and polyurethanes.

18. The printable media of claim 15, wherein the solid material is approximately 55% to 75% of the weight of the topcoat layer.

19. The printable media of claim 15, wherein the binder material is approximately 25% to 45% of the weight of the topcoat layer.

20. The printable media of claim 15, wherein:
the solid material has a volume;
the binder material has a volume;
the ratio of the solid material volume to the binder material volume is approximately 0.9 to 1.25 in the topcoat layer.
